(19) United States
(12) Patent Application Publication
(10) Pub. No.: US 2003/0132160 A1
(43) Pub. Date: Jul. 17, 2003

(54) Membrane biotreatment

(76) Inventor: Boris M. Khudenko, Atlanta, GA (US)

Correspondence Address: Boris M. Khudenko, 744 Moores Mill Rd., Atlanta, GA, 30327, US

(21) Appl. No.: 10/044,492

(22) Filed: Jan. 11, 2002

(51) Int. Cl. C02F 3/30

(52) U.S. Cl. 210/605

(57) ABSTRACT

A method of biological waste treatment with membrane separation of biomass having at least one chemical and/or biological oxidizing step and at least one chemical and/or biological reducing step, and further comprising a step of charging at least one recuperable oxidation-reduction specie selected from transitional elements, for example, iron ions, wherein biomass generation is reduced and biomass-water separation improve.

### FIELD OF INVENTION

The present method belongs to improved biological treatment of wastewater using membranes for biomass separation and retention in biological reactors.

### PRIOR ART

Gravity separation devices are commonly used for biomass separation from liquid being treated in biological processes, for example in wastewater treatment, or in biological reactors in food, pharmaceutical and other industries. Means for sludge return, such as pumps or airlifts (gaslifts), in the reactors are used. Built-in gravity clarifiers sometimes do not need means for sludge return. Centrifuges are occasionally also used for sludge separation. A disadvantage of these methods is that the residual suspended solids concentration in the effluent is noticeably high: from few milligrams to few hundred milligrams per liter and sometimes even greater. Accordingly, tertiary treatment devices, for example, granular bed filters, cloth filters, and other filters, including microfilters with plastic and/or ceramic membranes are used. Tertiary treatment complicates the system and involves additional capital and operating costs.

Recently, membrane filters have been used instead of gravity sludge separation and tertiary filtration means. Usually, plastic and/or ceramic membranes are used to separate the biomass, retain it in the biological reactor, and produce the wastewater effluent with very low concentration of suspended solids. Accordingly, the functions of the secondary and tertiary treatment devices are combined, thus making the system simpler and less expensive. Moreover, the biomass concentration in reactors is much greater than that with the use of gravity separators, thus the process rate is increased and the reactor volume is decreased. The treatment efficiency of membrane systems meets the present environmental regulations.

At present, membrane separation of biomass had been well tested in the laboratories, pilot plants, and several full scale installations for wastewater treatment. Membranes have also been used in full scale pharmaceutical and other biotechnology systems. Various types of membranes are used, mainly, synthetic plastic membranes made of sheet material or hollow fibers, and ceramic cartridges with hollow rods having multiple passages. Water flows across the membranes due to the pressure differential wich can be produced by one of the well known methods: creating pressure before the membrane or creating vacuum after the membrane, or by a combination of both. Membranes are assembled into modules submerged into the mixed liquor in biological reactors or in separate vessel communicating with the biological reactor. Air sparging around membranes is often used in order to prevent clogging and mechanical deposits on the membrane surfaces.

Operational experience with membrane separators of biomass has revealed a problem: the excess biomass wasted from membrane bioreactors separates from the mixed liquor very poorly, thus making sludge treatment difficult and expensive. There are two obvious directions for solving the problem: (1) to reduce or to virtually eliminate the formation of the excess biomass, and (2) to improve properties of the biomass in a way that helps to separate the biomass from the mixed liquor. Poor cleaning of membraned by air scour is sometimes a problem.

The objective of the present invention is to provide a method with significant reduction in the generation of the waste biomass in membrane bioreactors.

It is also the objective of the present invention to improve the separation properties of the biomass.

It is another objective to improve membrane cleaning.

Other objectives of the present invention will become apparent from the ensuing description.

### SUMMARY OF THE INVENTION

This is a method of biological treatment with membrane separation of biomass from mixed liquor wherein at least one oxidizing step and at least one reducing step are provided. This method further comprises a step of providing at least one intermediate oxidation-reduction specie in said at least one oxidizing step and said at least one reducing step. Accordingly, the organics in the mixed liquor, including the biomass, are intermittently subjected to chemical and/or biochemical oxidation and reduction actions, and are at least partially degraded. Accordingly, the mass of wasted sludge which needs treatment and disposal is reduced. Additionally, sequential and/or intermittent oxidation-reduction treatment or mixed liquor produces better settling sludge, as characterized, for example by a smaller sludge volume index.

The method further comprises a step of providing at least one adsorbent, for example, activated carbon. The adsorbed constituents of the mixed liquor are subjected to intermittent oxidizing and reducing actions and the adsorption capacity of the adsorbent becomes regenerated. The method can make use of activated carbons and their modifications made from various materials (wood, bone, nut shell, coal, and other) known under various names, including powdered and granular forms, synthetic adsorbents, including various ion exchangers, and other adsorbent materials known to skilled in the arts.

The method can be used at municipal and industrial wastewater treatment plants for treatment of wastewater, sludges, and gaseous emissions, including odor control in gaseous phase and odor prevention in the liquid phase, municipal and industrial sewers, solid waste treatment systems, solid waste collection and transfer systems, system for management of animal wastes, system for managing agricultural wastes, air pollution control systems, and combinations thereof.

The oxidizing step can be a chemical oxidation, or a biological oxidation, or both. The chemical oxidations can be conducted, for example, with hydrogen peroxide, hypochlorite, nitrates, oxygen, ozone, permanganate, and combinations thereof. The biological oxidations can be conducted, for example, with nitrites, nitrates, oxygen, and combinations thereof. The reducing step can be either a chemical reduction, or a biological reduction, or both. The chemical and/or biological reduction can be conducted with reducing reagents, for example, sulfites, sulfides, hypophosphates, organics, and their combinations. Subjecting the adsorbent to intermittent oxidation and reduction conditions facilitates regeneration of adsorbents within the process thus avoiding the withdrawal and separate regeneration of adsorbents. The nondegradable constituents of pollution accumulated on the adsorption sites during the oxidation portion of the operation can be significantly degraded in the reduction portion of the operation. Conversely, the nondegradable constituents of pollution accumulated on the adsorption sites during the reduction portion of the operation can be significantly degraded in the oxidation portion of the operation. This unexpected effect significantly prolongs the life of adsorbents and drastically reduces the need in the virgin adsorbent, which is a great benefit of the process.

The method provides for a step of charging at least one recuperable oxidation-reduction specie in the treatment system. The preferred recuperable oxidation-reduction species are transitional elements, for example, vanadium, chromium, manganese, iron, cobalt, nickel, and combinations of these metals, with iron being the most preferred in many simple cases. Iron ions can be present in oxidized and reduced forms: ferric and ferrous ions. Both, ferrous and ferric ions form practically insoluble flocculating hydroxides in the most practicable pH ranges. Calcium added as a recuperable alkaline specie forms insoluble calcium carbonate. Accordingly, iron and calcium are easily retained and recuperated in the system by the solid-liquid separation means. Accordingly, these species are called herein the recuperable species. Iron hydroxide is a good flocculant for biomass and calcium carbonate is a ballast, together these ions improve biomass flock settling and separation properties. In various processes involving oxidation and reduction steps, ferrous ions can be oxidized to ferric ions in one step, for example in the denitrification via reaction with nitrates and nitrites, and thus formed ferric ions can be reduced to ferrous ions in another step, for example, step of biomass and/or organics oxidation by ferric ions. Other recuperable species can also form ions in at least two oxidation states, these ions also form flocculating hydroxides.

The use of adsorbents, primarily PAC and GAC, and the recuperable oxidation-reduction species, preferably iron, in biological processes with sludge oxidation steps additionally produces very valuable synergistic effects: oxidation and significant reduction or elimination of sludge by the recuperable oxidation-reduction species reduces or eliminates the adsorbent loss with the excess sludge. Simultaneously, adsorbents are well regenerated through the alternating exposure to the oxidation and reduction conditions. The use of the recuperable oxidation-reduction species further improves the adsorbent regeneration, while the concentrating of constituents to be treated by the adsorbents increases the effectiveness of the recuperable oxidation-reduction species. This synergistic effect results in benefits far surpassing any additive effects of the use of adsorbents and recuperable oxidation-reduction species.

The recuperable oxidation-reduction species can be fed in the wastewater management system in form of zero valence metals being dissolved in the waste being treated, metal salts, inorganic metal-containing compounds, and organic metal-containing compounds which emit the metal ions in the waste upon degradation of these organics. The recuperable oxidation-reduction specie can also be a precipitating reagent.

This method further provides a step of adding at least one specie for controlling alkalinity and pH, particularly by providing alkali metal ions, alkali earth metal ions, biodegradable organics incorporating alkali, alkali earth, and other metals capable of providing alkalinity and pH buffering upon biodegradation, and combinations of these constituents. Addition of recuperable alkaline species as described in the U.S. Pat. No. 5,798,043, which is made part of the present specification by inclusion.

The alternating exposure of adsorbents to oxidizing and reducing steps can be achieved in sequencing batch operations, flow-through operations, or combinations of both. The oxidation and reduction process steps can be provided in time-separated manner in sequencing batch reactors with at last one oxidation period and at least one reduction period, in space separated manner in a series of tanks or cells with alternating oxidizing and reducing conditions, optionally, with recycle of their contents among the tanks, or cells, and also with oxidation-reduction steps provided in a single tank due to the heterogenous properties of the mixed liquor. In the latter case, the outer layer of activated sludge flock or a particle of adsorbent carrying biomass can be aerobic (oxidizing) while the core of the flock or particle can be anaerobic (reducing).

The present method also provides for a fluidizable particulate material under membrane modules, especially hollow fiber and ceramic membranes. The fluidizable material can be sand, crushed glass or glass beads, garnet, ilmenite, crushed slugs, granular activated carbon, plastic beads, and combinations of these materials. Other materials known to skilled in arts can also be used. At least periodically, these materials can be fluidized and scour the deposits from the membrane surface. Fluidization can be achieved by water, air, and combination of both.

A step of stripping carbon dioxide prior to membrane filtration can also be provided. This causes more efficient precipitation of iron hydroxide and calcium carbonate into biomass. Accordingly, the potential for depositing these compounds on the membrane is greatly reduced.

The present method produces tremendous reduction in the biomass generation. Additionally, iron and calcium added to the mixed liquor coagulate the biomass and make flocks heavier, both factors are improving biomass separation from water.

While the invention has been described in detail with the particular reference to preferred embodiments thereof, it will be understood that variations and modifications can be effected within the spirit and the scope of the invention as previously described and as defined by the claims.

What is claimed is:

1. A method of biological treatment with membrane separation of biomass from mixed liquor wherein at least one oxidizing step and at least one reducing step are provided.

2. The method of claim 1, wherein said biological treatment is selected from the group consisting of odor control system, air pollution control system, wastewater treatment plant, sewers, solid waste treatment system, solid waste collection and transfer system, system for management of animal waste, system for managing agricultural waste, and combinations thereof.

3. The method of claim 1, wherein said at least one oxidizing step is selected from the group consisting of chemical oxidation, biological oxidation, and combinations thereof.

4. The method of claim 1, wherein said oxidizing step is conducted with an oxidant selected from the group consisting of hydrogen peroxide, hypochlorites, nitrates, nitrites, oxygen, ozone, permanganates, and combinations thereof.

5. The method of claim 1, wherein said at least one reducing step is selected from the group consisting of chemical reduction, biological reduction, and combinations thereof.

6. The method of claim 1, wherein said reducing step is conducted with a reductant selected from the group consisting of sulfites, sulfides, hypophosphates, organics, and combinations thereof.

7. The method of claim 1 and further providing a step of charging at least one recuperable oxidation-reduction specie.

8. The method of claim 7, wherein said at least one recuperable oxidation-reduction specie is a transitional element.

9. The method of claim 8, wherein said transitional elements are selected from the group comprising vanadium, chromium, manganese, iron, cobalt, nickel, and combinations thereof.

10. The method of claim 7, wherein said at least one recuperable oxidation-reduction specie is fed in said wastewater management system in form selected from the group comprising zero valence metals, metal salts, inorganic metal-containing compounds, organic metal-containing compounds, and combinations thereof.

11. The method of claim 7 and further providing at least one step of re-oxidizing said recuperable oxidation-reduction specie.

12. The method of claim 11, wherein said at least one step of re-oxidizing said recuperable oxidation-reduction specie is conducted with an oxidizer selected from the group consisting of hydrogen peroxide, hypochlorites, nitrates, oxygen, ozone, permanganates, and combinations thereof.

13. The method of claim 2, wherein at least one adsorbent and least one oxidation-reduction specie is provided in said sewer from said wastewater treatment plant.

14. The method of claim 13, wherein said providing of at least one oxidation-reduction specie is conducted by means selected from a group consisting of a pipeline, a truck transportation, a rail transportation, and combinations thereof.

15. The method of claim 1 and further providing an adsorbent in said biological treatment.

16. The method of claim 15, wherein said adsorbent is selected from the group comprising activated carbon, synthetic resins, ion exchangers, and combinations thereof.

17. The method of claim 1 and further providing a step of at least periodically cleaning said membrane by fluidizing at least one particulate medium around said membrane.

18. The method of claim 17, wherein said particulate medium is selected from the group comprising mineral particulate materials, synthetic particulate materials, sand, garnet, ilmenite, coal, granular activated carbon, crashed glass, glass beads, plastic beads, and combinations thereof.

19. The method of claim 1, wherein a step of stripping carbon dioxide is provided.

20. The method of claim 1, wherein a step of charging at least one recuperable alkaline specie is provided.

21. The method of claim 1, wherein said oxidizing steps and said reducing steps are selected from the group comprising se quential steps in sequencing batch reactor, alternating steps in sequencing batch reactor, consecutive steps in a multiple cell flow through reactor, consecutive steps in a multiple cell flow through reactor with flow recirculating, steps carried out in heterogeneous system, and combinations thereof.
